(19) United States
(12) Patent Application Publication
(10) Pub. No.: US 2016/0210901 A1
(43) Pub. Date: Jul. 21, 2016

(54) DISPLAY DEVICE AND DRIVING METHOD THEREOF

(71) Applicant: Samsung Display Co., Ltd., Yongin-si (KR)

(72) Inventors: Ui Yeong CHA, Hwaseong-si (KR); In Hwan KIM, Asan-si (KR)

(21) Appl. No.: 14/850,931

(22) Filed: Sep. 10, 2015

(30) Foreign Application Priority Data
Jan. 16, 2015 (KR) 10-2015-0008168

(51) Int. Cl. G09G 3/32; G09G 5/10

(52) U.S. Cl. CPC G09G 3/3258; G09G 5/10; G09G 2320/0686; G09G 2320/0626

(57) ABSTRACT

Provided are a display device and a driving method thereof. The display device includes a display panel, a luminance compensator, and a signal controller. The display panel includes a first curved portion having a first curvature degree and a second curved portion having a second curvature degree different from the first curvature degree. The luminance compensator sets a first luminance compensation value corresponding to the first curved portion and sets the first luminance compensation value as a second luminance compensation value corresponding to the second curved portion. The signal controller compensates an input image signal input in response to the luminance compensation value set by the luminance compensator.

### CROSS-REFERENCE TO RELATED APPLICATION

This application claims priority to and the benefit of Korean Patent Application No. 10-2015-0008168, filed in the Korean Intellectual Property Office on Jan. 16, 2015, the content of which is incorporated herein by reference in its entirety.

### BACKGROUND

1. Field

Aspects of embodiments of the present disclosure relate to a display device and a driving method thereof.

2. Description of the Related Art

Among various kinds of display devices, an organic light emitting diode display uses (e.g., includes) organic light emitting diodes (OLEDs), in which luminance is controlled by current and/or voltage. Each OLED includes an anode layer and a cathode layer forming an electric field, and an organic emission material emitting which emits light due to the electric field.

Generally, the OLEDs may be classified into passive matrix OLEDs (PMOLED) or active matrix OLEDs (AMOLED) according to a driving method thereof.

With respect to a resolution, a contrast, and an operational speed, the AMOLED display, which selectively turns on each unit pixel, has become more common than the PMOLED display. One frame of the AMOLED display includes a scan period for writing image data and a light emission period for emitting light according to the written image data.

In the organic light emitting diode display, difference in characteristics, such as an operation voltage Vth, mobility, and the like, between the driving transistor for each pixel may occur due to a process deviation and the like, and as a result, difference in luminance between pixels occurs. In addition, the organic light emitting diode display may be implemented as a curved panel due to a characteristic of the OLED. In the organic light emitting diode display implemented as the curved panel (e.g., in the curved organic light emitting diode display), the difference in luminance may be further increased due to the curved panel.

The above information disclosed in this Background section is only for enhancement of understanding of the background of the disclosure and, therefore, it may contain information that does not form the prior art that is already known to a person of ordinary skill in the art.

### SUMMARY

Aspects of embodiment of the present disclosure provide a display device and a driving method thereof which compensates for a luminance deviation.

An exemplary embodiment of the present disclosure provides a display device including a display panel including a first curved portion having a first curvature degree and a second curved portion having a second curvature degree different from the first curvature degree, a luminance compensator configured to set a first luminance compensation value corresponding to the first curved portion and set the first luminance compensation value as a second luminance compensation value corresponding to the second curved portion, and a signal controller configured to compensate an input image signal according to the first and second luminance compensation values set by the luminance compensator and transmit the compensated image signal to be displayed on the display panel.

The luminance compensator may be configured to receive imaging data acquired by photographing the display panel by a photographing unit and set the first luminance compensation value by utilizing the imaging data and the first curvature degree.

The first and second curvature degrees may be curvature radiuses, and the curvature radius corresponding to the second curvature degree may be less than the curvature radius corresponding to the first curvature degree.

The second curved portion may be farther from a center of the display panel than the first curved portion. The second curved portion may include an end portion of the display panel.

The display panel may further include a planar portion, and the luminance compensator may be configured to set the luminance compensation value for the planar portion by utilizing the imaging data corresponding to the planarization portion.

The imaging data may include data from the photographing unit configured to photograph a test image.

Another exemplary embodiment of the present disclosure provides a driving method of a display device including a display panel including first and second curved portions having different curvature radiuses and a driver configured to drive the display panel. The driving method of the display device includes setting a first luminance compensation value corresponding to the curvature radius of the first curved portion, setting the first luminance compensation value as a second luminance compensation value corresponding to the second curved portion, compensating an input image signal according to the first luminance compensation value and the second luminance compensation value, and transmitting the compensated image signal to the display panel.

The setting of the first luminance compensation value may include receiving imaging data from a photographing unit acquired by photographing the display panel, and setting the first luminance compensation value by utilizing the imaging data corresponding to the first curved portion and the curvature radius of the first curved portion.

The curvature radius of the second curved portion may be less than the curvature radius of the first curved portion.

The second curved portion may be farther from a center of the display panel than the first curved portion.

The driving method may further include setting a luminance compensation value for a planar portion of the display panel by utilizing the imaging data corresponding to the planar portion.

According to exemplary embodiments of the present disclosure, a luminance deviation of a curved panel may be compensated for by considering a curvature degree of the curved panel.

Further, a luminance deviation with respect to a portion of the curved panel where the curvature is relatively large may also be compensated for.

### BRIEF DESCRIPTION OF THE DRAWINGS

FIG. 1 is a diagram illustrating a display device according to an exemplary embodiment of the present disclosure.

FIG. 2 is a plan view illustrating a curved structure of a display panel according to an exemplary embodiment of the present disclosure.

FIG. 3 is a diagram illustrating imaging data of a photographing unit according to an exemplary embodiment of the present disclosure.

FIG. 4 is a diagram illustrating a luminance compensating method of a luminance compensator according to a first exemplary embodiment of the present disclosure.

FIG. 5 is a diagram illustrating a luminance compensating method of a luminance compensator according to a second exemplary embodiment of the present disclosure.

FIG. 6 is a flowchart illustrating the luminance compensating method of the luminance compensator according to the second exemplary embodiment of the present disclosure.

### DETAILED DESCRIPTION

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

Further, in the described exemplary embodiments, like reference numerals designate like elements having the same configuration. Thus, a first exemplary embodiment is representatively described, and in other exemplary embodiments, only a configuration or components different from those of the first exemplary embodiment may be described.

The drawings and description are to be regarded as illustrative in nature and not restrictive. The terminology used herein is for the purpose of describing particular example embodiments only and is not intended to be limiting of example embodiments. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, tasks, operations, elements, and/or components, but do not preclude the presence or addition of one or more other features, integers, steps, tasks, operations, elements, components, and/or groups thereof.

It will be understood that when an element is referred to as being “on”, “connected to”, or “coupled to” another element, it may be directly on, connected, or coupled to the other element or one or more intervening elements may also be present. When an element is referred to as being “directly on,” “directly connected to,” or “directly coupled to” another element, there are no intervening elements present. For example, when a first element is described as being “coupled” or “connected” to a second element, the first element may be directly coupled or connected to the second element or the first element may be indirectly coupled or connected to the second element via one or more intervening elements. As used herein, the term “and/or” includes any and all combinations of one or more of the associated listed items. Further, the use of “may” when describing embodiments of the present invention relates to “one or more embodiments of the present invention”. Expressions, such as “at least one of,” when preceding a list of elements, modify the entire list of elements and do not modify the individual elements of the list. Also, the term “exemplary” is intended to refer to an example or illustration.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments. In the figures, dimensions of the various elements, layers, etc. may be exaggerated for clarity of illustration.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly. As used herein, the terms “use,” “using,” and “used” may be considered synonymous with the terms “utilize,” “utilizing,” and “utilized,” respectively.

The signal controller, data driver, luminance compensator, and/or any other relevant devices or components of the display device according to embodiments of the present invention described herein may be implemented utilizing any suitable hardware, firmware (e.g. an application-specific integrated circuit), software, or a suitable combination of software, firmware, and hardware. For example, the various components of the display device may be formed on one integrated circuit (IC) chip or on separate IC chips. Further, the various components of the display device may be implemented on a flexible printed circuit film, a tape carrier package (TCP), a printed circuit board (PCB), or formed on a same substrate as the display device. Further, the various components of the display device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

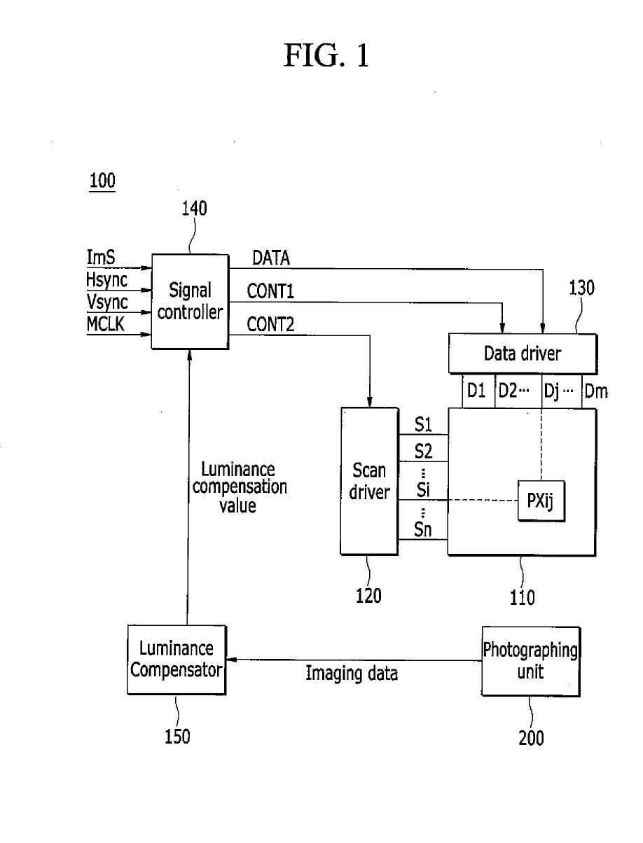

FIG. 1 is a diagram illustrating a display device 100 according to an exemplary embodiment of the present disclosure.

As illustrated in FIG. 1, the display device 100 according to an exemplary embodiment of the present disclosure includes a display panel 110, a scan driver 120, a data driver 130, a signal controller 140, and a luminance compensator 150 (e.g., a luminance compensating unit).

The display panel 110 includes a plurality of pixels PXij, each of which is connected to a corresponding scan line from among a plurality of scan lines S1-Sn and a corresponding data line from among a plurality of data lines D1-Dm. Each of the plurality of pixels displays an image (or a portion of an image) in response to an image data signal transferred to the corresponding pixel.

Each of the plurality of pixels included in the display panel 110 is connected to at least one of the plurality of scan lines S1-Sn and at least one of the plurality of data lines D1-Dm, and the plurality of pixels are arranged substantially in a matrix form between ones of the scan lines S1-Sn and the data lines D1-Dm. The plurality of scan lines S1-Sn extend substantially in a row direction to be substantially parallel to each other. The plurality of data lines D1-Dm extend substantially in a column direction to be substantially parallel to each other. Each of the plurality of pixels of the display panel 110 receives a power voltage from a power voltage supply (e.g., a power voltage supplying unit) and receives a first driving voltage ELVDD and a second driving voltage ELVSS.

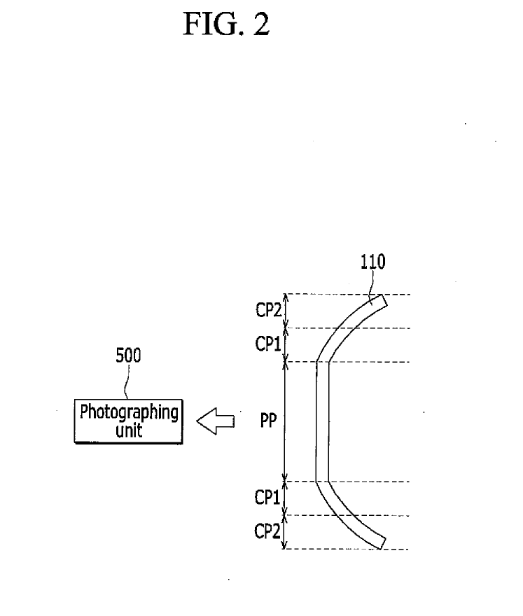

The display panel 110 according to an exemplary embodiment of the present disclosure has a curved structure and will be described in further detail with reference to FIG. 2 below.

The scan driver 120 is connected to the display panel 110 through the plurality of scan lines S1-Sn. The scan driver 120 generates a plurality of scan signals capable of activating (e.g., configured to activate) each pixel of the display panel 110 according to a scan control signal CONT2 by transferring ones of the plurality of scan signals to the corresponding scan line from among the plurality of scan lines S1-Sn.

The scan control signal CONT2 is an operation control signal of the scan driver 120 which is generated and transferred from the signal controller 140. The scan control signal CONT2 may include a scan start signal, a clock signal, and the like. The scan start signal is a signal including (e.g., generating) a first scan signal for displaying an image in one frame. The clock signal is a synchronization signal for sequentially applying the scan signals to the plurality of scan lines S1-Sn.

The scan driver 120 generates a plurality of scan signals S[1]-S[n] according to a scan control signal CONT2. The scan driver 120 may sequentially apply the scan signals S[1]-S[n] corresponding to a gate-on voltage to the plurality of scan lines.

The data driver 130 is connected to each pixel of the display panel 110 through the plurality of data lines D1-Dm. The data driver 130 receives an image data signal DATA and transfers the image data signal DATA to the corresponding data line from among the plurality of data lines D1-Dm according to a data control signal CONT1.

The data control signal CONT1 is an operation control signal of the data driver 130 which is generated by and transferred from the signal controller 140.

The data driver 130 selects a gray voltage according to an image data signal DATA and transfers the selected gray voltage to the plurality of data lines D1-Dm as a data signal.

The signal controller 140 receives an image signal ImS input from the outside and an input control signal controlling display of the image signal. The image signal ImS includes (e.g., stores) luminance information for (e.g., corresponding to) each pixel of the display device 100, and the luminance may be divided into a certain number (e.g., a predetermined number), for example, 1024, 256, or 64 grays.

An example of the input control signal transferred to the signal controller 140 includes a vertical synchronization signal Vsync, a horizontal synchronization signal Hsync, a main clock MCLK, a data enable signal DE, and the like.

The signal controller 140 generates first and second driving control signals CONTI and CONT2 and an image data signal DATA according to the image signal ImS, the horizontal synchronization signal Hsync, the vertical synchronization signal Vsync, and the main clock signal MCLK.

The signal controller 140 image-processes the image signal ImS according to operational conditions of the display panel 110 and the data driver 130 based on the input image signal ImS and the input control signals Hsync, Vsync, and MCLK. The signal controller 140 according to an exemplary embodiment of the present disclosure receives a luminance compensation value from the luminance compensator 150 and performs luminance compensation by changing (e.g., adjusting or varying) the image signal ImS according to the luminance compensation value. A method of compensating for the luminance will be described in further detail with reference to FIGS. 2 to 6.

The signal controller 140 generates the data control signal CONT1 for controlling an operation of the data driver 130 and transfers the data control signal CONT1 in addition to the image data signal DATA to the data driver 130 through (e.g., during) the image processing process. The signal controller 140 also transfers the scan control signal CONT2 for controlling an operation of the scan driver 120 to the scan driver 120.

The photographing unit 200 photographs the image applied to the display panel 110 of the completed display device 100. In order to compensate for luminance differences between each of the pixels of the display panel 110, the display device 100 displays a test image for compensating luminance on the display panel 110. In one embodiment, the test image for compensating luminance may be a red R image in which the entire screen image has a first gray (e.g., display a first grey value), a green G image in which the entire screen image has a second gray (e.g., display a second grey value), and a green G image in which the entire screen image has a third gray (e.g., display a third grey value). The photographing unit 200 photographs the test image for compensating luminance and transmits imaging data to the luminance compensator 150. The photographing unit 200 is installed (e.g., implemented) at a separate production process from that of the display device 100 and may be implemented by a CCD camera and the like.

The luminance compensator 150 according to an exemplary embodiment of the present disclosure receives the imaging data from the photographing unit 200 and calculates the luminance compensation value of each pixel by using the imaging data. The luminance compensator 150 has (e.g., has stored in its memory) a normal imaging data value corresponding to the test image, and the normal imaging data value is set to reference imaging data. Accordingly, the luminance compensator 150 compares actual imaging data received from the photographing unit 200 with the reference imaging data value and calculates the luminance compensation value in response to a difference between the data. The luminance compensation value calculated above may be stored in a separate memory.

For example, with respect to an R test image having the first gray, when an imaging data value of one of the pixels (e.g., a predetermined pixel) is lower than the reference imaging data value, the luminance compensator 150 sets the luminance compensation value to be relatively high. The signal controller 140, receiving the relatively high luminance compensation value, sets the image signal of the corresponding pixel to be greater (e.g., to have a greater grey value) than the input image signal ImS in order to compensate for the luminance value of the corresponding pixel.

The luminance compensator 150 according to an exemplary embodiment of the present disclosure additionally set a luminance compensation value by considering the curvature degree with respect to a portion of a curved surface of the display panel 110 (e.g., with respect to a curved portion of the display panel 110). A method of setting the additional luminance compensation value will be described in further detail with reference to FIGS. 2 to 6.

The display panel 110 according to an exemplary embodiment of the present disclosure will be described in more detail with reference to FIG. 2.

FIG. 2 is a plan view illustrating a curved structure (e.g., a curvature structure) of the display panel 110 according to an exemplary embodiment of the present disclosure.

As illustrated in FIG. 2, the display panel 110 according to an exemplary embodiment of the present disclosure includes a planar portion PP (e.g., a planarization portion), a first curved portion CP1 (e.g., a first curvature portion), and a second curved portion CP2 (e.g., a second curvature portion).

The planar portion PP has a planar structure in which a portion where the image is displayed is flat or substantially flat.

The first curved portion CP1 has a first curvature degree in which the portion where the image is displayed is not flat (e.g., is curved).

In addition, the second curved portion CP2 has a second curvature degree in which the portion where the image is displayed is not flat (e.g., is curved). In one embodiment, the curvature degree is a value representing a bending degree of the display panel 110 and may be referred to as a curvature radius R.

In FIG. 2, it is assumed that the second curved portion CP2 is bent to same amount or is less bent than the first curved portion CP1. For example, the curvature radius of the second curved portion CP2 has a smaller value than the curvature radius of the first curved portion CP1.

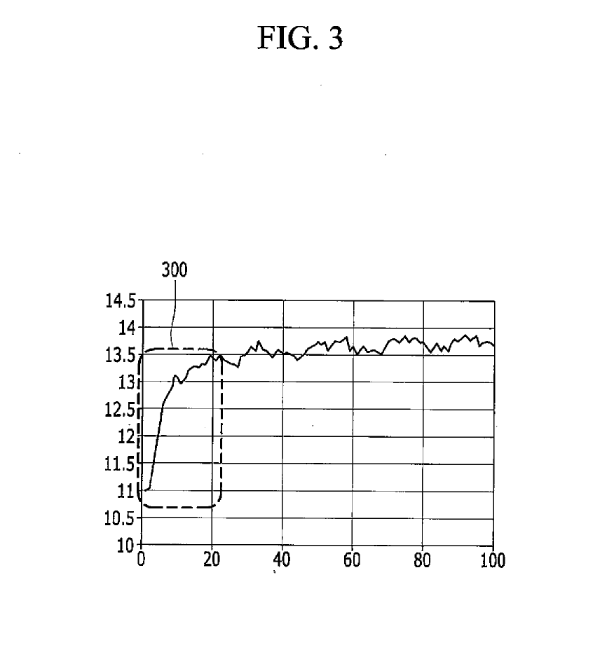

As illustrated in FIG. 2, the photographing unit 500 photographs the test image displayed on the display panel 110 having the curved structure. Due to the curved structure of the display panel 110, the imaging data photographed by the photographing unit 500 may be distorted. FIG. 3 is a diagram illustrating distortion of the photographed imaging data.

FIG. 3 is a diagram illustrating imaging data of the photographing unit 500 according to the above-described exemplary embodiment of the display panel 110 of the present disclosure.

In FIG. 3, reference numeral 300 represents imaging data corresponding to the first and second curved portions CP1 and CP2. Referring to 300 of FIG. 3, the imaging data corresponding to the first and second curved portions CP1 and CP2 is distorted due to the curvature of the display panel 110. Because a distance between the first and second curved portions CP1 and CP2 and the photographing unit 500 is farther than a distance between the planar portion PP and the photographing unit 500, a value of the imaging data becomes smaller (e.g., artificially smaller). The imaging data corresponding to a portion having a greater curvature or an end portion of the second curved portion CP2 may be completely lost (e.g., may not be captured by the photographing unit 500).

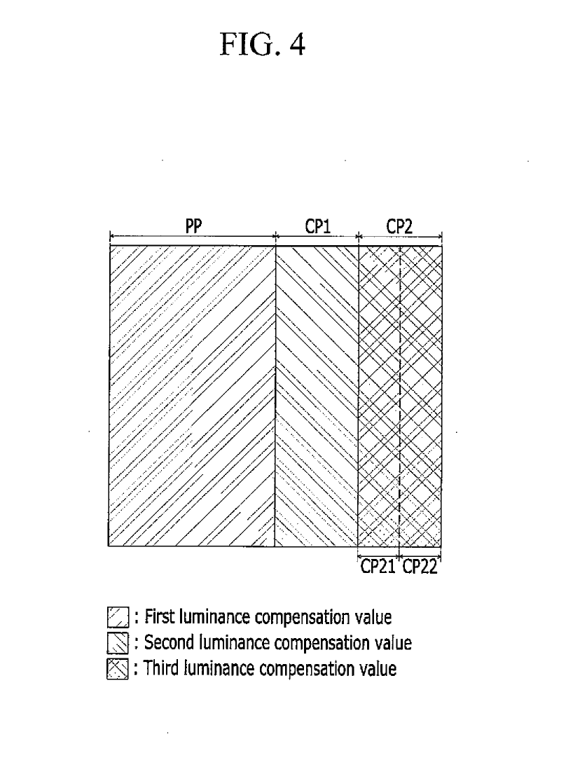

The luminance compensator 150 according to an exemplary embodiment of the present disclosure additionally compensates for the distortion of the imaging data due to the curved structure of the display panel 110. A method of compensating for the distortion of the imaging data due to the curvature of the display panel 110 will be further described with reference to FIGS. 4 to 6.

FIG. 4 is a diagram illustrating a luminance compensating method of the luminance compensator 150 according to a first exemplary embodiment of the present disclosure. In addition, the screen illustrated in FIG. 4 represents a front view of the display panel 110.

The luminance compensator 150 compares the imaging data corresponding to the planar portion PP with the reference imaging data to set a first luminance compensation value with respect to the planar portion PP.

As illustrated in FIG. 4, the luminance compensator 150 compares the reference imaging data with the imaging data corresponding to the first curved portion CP1, sets the luminance compensation value, and additionally sets (e.g., finally sets) the luminance compensation value of the first curved portion CP1 by considering the curvature degree of the first curved portion CP1. For example, the luminance compensator 150 sets the luminance compensation value by considering the curvature degree as well as the imaging data with respect to the first curved portion CP1. In FIG. 4, the luminance compensation value of the first curved portion CP1, which is finally set, is represented as a second luminance compensation value.

In addition, the luminance compensator 150 sets the luminance compensation value by considering the curvature degree of the second curved portion CP2, similar to how the luminance compensator 150 sets the second luminance compensation value corresponding to the first curved portion CP1. For example, the luminance compensator 150 sets the luminance compensation value by considering the curvature degree as well as the imaging data with respect to the second curved portion CP2. In FIG. 4, the luminance compensation value of the second curved portion CP2, which is finally set, is represented as a third luminance compensation value.

The first to third luminance compensation values described above each have a plurality of luminance compensation values with respect to each corresponding pixel.

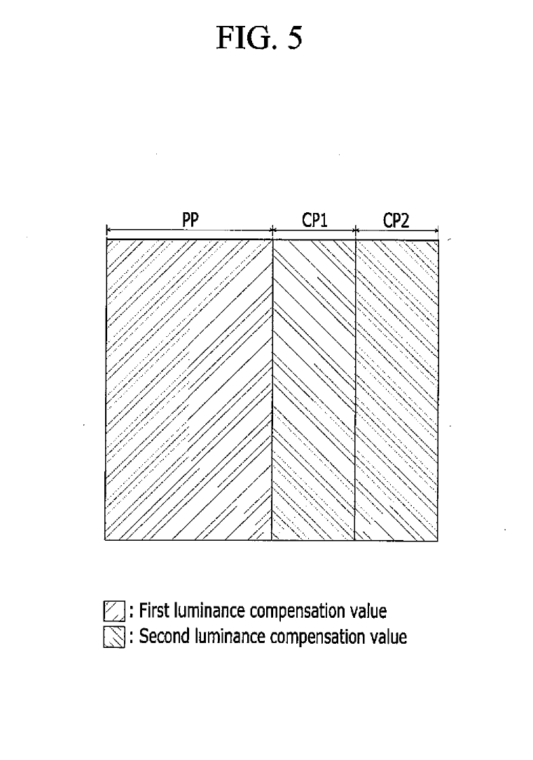

As illustrated in FIG. 4, the second curved portion CP2 may be defined by a distorted portion CP21 and a loss portion CP22. The distorted portion CP21 is a portion where the imaging data value exists (e.g., is captured by the photographing unit 500) but reliability of the value deteriorates, and the loss portion CP22 is a portion where the imaging data does not exist (e.g., is a portion where the photographing unit 500 cannot capture the imaging data). A luminance compensating method for when the second curved portion CP2 is defined by the distorted portion CP21 and the loss portion CP22 will be further described with reference to FIG. 5.

FIG. 5 is a diagram illustrating a luminance compensating method of the luminance compensator 150 according to a second exemplary embodiment of the present disclosure.

As illustrated in FIG. 5, the luminance compensator 150 sets luminance compensation values with respect to the planar portion PP and the first curved portion CP1, the same or similar to the above-described first exemplary embodiment.

The luminance compensator 150 copies the second luminance compensation value, which is the luminance compensation value of the first curved portion CP1, with respect to the second curved portion CP2. For example, the luminance compensation value of the second curved portion CP2 is set to be the same as the luminance compensation value of the first curved portion CP1.

As such, the luminance compensator 150 copies and sets the luminance compensation value of the first curved portion CP1 as that of the second curved portion CP2, and as a result, reliability of the luminance compensation value may be enhanced.

In addition, because the luminance compensation value of the second curved portion CP2 is a copy of the closest luminance compensation value of the first curved portion CP1, an available luminance compensation value may be obtained with respect to compensation of spots occupying a relatively small region of the entire display panel 110.

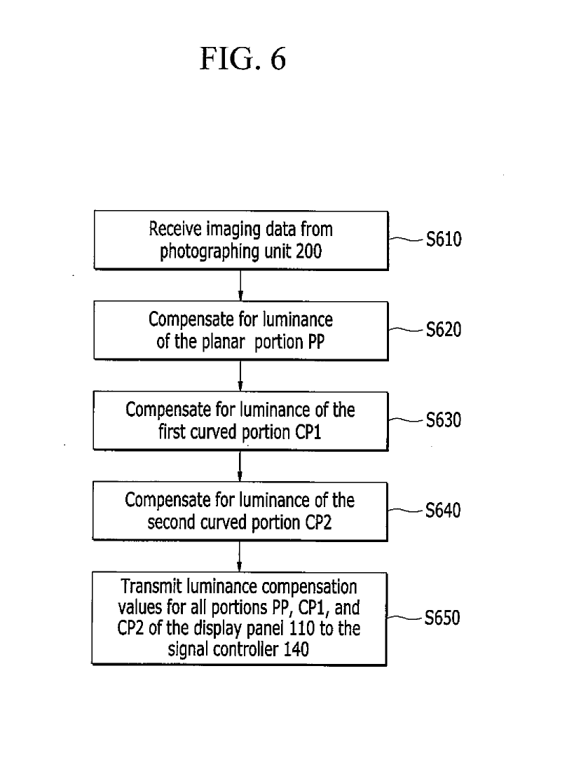

FIG. 6 is a flowchart illustrating the luminance compensating method of the luminance compensator 150 according to the second exemplary embodiment of the present disclosure.

First, the photographing unit 200 photographs all portions (e.g., entire portions) of the display panel 110 to generate the imaging data, and the luminance compensator 150 receives the imaging data (S610).

The luminance compensator 150 compensates for the luminance with respect to the planar portion PP (S620). For example, the luminance compensator 150 compares the reference imaging data with the imaging data corresponding to the planar portion PP and sets the first luminance compensation value with respect to the planar portion PP.

Next, the luminance compensator 150 compensates for the luminance with respect to the first curved portion CP1 (S630). For example, the luminance compensator 150 sets the second luminance compensation value with respect to the first curved portion CP1 by considering the imaging data and the curvature degree corresponding to the first curved portion CP1.

In addition, the luminance compensator 150 compensates for the luminance with respect to the second curved portion CP2 (S630). The luminance compensator 150 copies the second luminance compensation value, which is the luminance compensation value of the first curved portion CP1, with respect to the second curved portion CP2.

The luminance compensator 150 transmits the luminance compensation values with respect to all portions PP, CP1, and CP2 of the display panel 110 to the signal controller 140. For example, the luminance compensator 150 transmits the first luminance compensation value for the planar portion PP set in task S620, the second luminance compensation value for the first curved portion CP1 set in task S630, and the second luminance compensation value for the second curved portion CP2 set in task S640 to the signal controller 140. The signal controller 140 changes (e.g., adjusts or varies) the image signal ImS according to the luminance compensation values received from the luminance compensator 150, and as a result, the luminance compensation is performed.

Hereinabove, similar to FIG. 2, it is assumed and described that the display panel 110 has a convex curved structure facing the photographing unit 500. However, the luminance compensating method described above may be applied to a concave curved structure of the display panel 110 facing the photographing unit 500. Because the concave curved panel structure is substantially the same as the convex curved panel structure except how the imaging data value varies, it can be understood to those skilled in the art, and thus, a detailed description thereof is omitted.

While this disclosure has been described in connection with what is presently considered to be practical exemplary embodiments, it is to be understood that the disclosure is not limited to the disclosed embodiments but, on the contrary, is intended to cover various modifications and equivalent arrangements included within the spirit and scope of the appended claims and their equivalents.

What is claimed is:

1. A display device comprising:
a display panel comprising a first curved portion having a first curvature degree and a second curved portion having a second curvature degree different from the first curvature degree;
a luminance compensator configured to set a first luminance compensation value corresponding to the first curved portion and set the first luminance compensation value as a second luminance compensation value corresponding to the second curved portion; and
a signal controller configured to compensate an input image signal according to the first and second luminance compensation values set by the luminance compensator and transmit the compensated image signal to be displayed on the display panel.

2. The display device of claim 1, wherein:
the luminance compensator is configured to receive imaging data acquired by photographing the display panel by a photographing unit and set the first luminance compensation value by utilizing the imaging data and the first curvature degree.

3. The display device of claim 2, wherein:
the display panel further comprises a planar portion, and
the luminance compensator is configured to set a luminance compensation value for the planar portion by utilizing the imaging data corresponding to the planar portion.

4. The display device of claim 2, wherein:
the imaging data comprises data from the photographing unit is configured to photograph a test image.

5. The display device of claim 1, wherein:
the first and second curvature degrees are curvature radiuses, and the curvature radius corresponding to the second curvature degree is less than the curvature radius corresponding to the first curvature degree.

6. The display device of claim 1, wherein:
the second curved portion is farther from a center of the display panel than the first curved portion.

7. The display device of claim 6, wherein:
the second curved portion comprises an end portion of the display panel.

8. A driving method of a display device comprising a display panel comprising first and second curved portions having different curvature radiuses and a driver configured to drive the display panel, the driving method comprising:
setting a first luminance compensation value corresponding to the first curved portion;
setting the first luminance compensation value as a second luminance compensation value corresponding to the second curved portion;
compensating an input image signal according to the first luminance compensation value and the second luminance compensation value; and
transmitting the compensated image signal to the display panel.

9. The driving method of claim 8, wherein:
the setting of the first luminance compensation value comprises:
receiving imaging data from a photographing unit acquired by photographing the display panel; and
setting the first luminance compensation value by utilizing the imaging data corresponding to the first curved portion and the curvature radius of the first curved portion.

10. The driving method of claim 9, further comprising:
setting a luminance compensation value for a planar portion of the display panel by utilizing the imaging data corresponding to the planar portion.

11. The driving method of claim 8, wherein:
the curvature radius of the second curved portion is less than the curvature radius of the first curved portion.

12. The driving method of claim 8, wherein:
the second curved portion is farther from a center of the display panel than the first curved portion.

13. A system for driving a display device, the display device comprising:
a display panel comprising a first curved portion having a first curvature degree and a second curved portion having a second curvature degree different from the first curvature degree;
means for setting set a first luminance compensation value corresponding to the first curved portion and setting the first luminance compensation value as a second luminance compensation value corresponding to the second curved portion; and
means for compensating an input image signal according to the first and second luminance compensation values and transmitting the compensated image signal to be displayed on the display panel.
